(19) United States
(12) Patent Application Publication
(10) Pub. No.: US 2007/0166534 A1
(43) Pub. Date: Jul. 19, 2007

(54) Surface-modified particles

(75) Inventors: Marc Entenmann, Fellbach (DE); Adalbert Huber, Bensheim (DE)

Correspondence Address: MILLEN, WHITE, ZELANO & BRANIGAN, P.C., 2200 CLARENDON BLVD., SUITE 1400, ARLINGTON, VA, 22201, US

(73) Assignee: MERCK PATENT GMBH, Darmstadt (DE)

(21) Appl. No.: 10/582,495

(22) PCT Filed: Nov. 13, 2004
(86) PCT No.: PCT/EP04/12882

§ 371 Date: Jun. 9, 2006

(30) Foreign Application Priority Data
Dec. 10, 2003 (DE) 103 58 092.1

(51) Int. Cl. B32B 27/20

(52) U.S. Cl. 428/336; 428/411.1; 428/500

(57) ABSTRACT

The invention relates to substrates with a surface modified by dyes, characterised in being enveloped in one or several layers of immobilised LCST and/or UCST polymers. The invention further relates to a method for the production of the surface-modified substrates and the use thereof in paints, water paints, dyes, printing dyes, security printing dyes, plastics, concrete, in cosmetic formulations, in agricultural films and tarpaulins, for the laser marking of paper and plastics, for laser welding, as light protective, as pigment for corrosion protection and in the production of pigment preparations and dry preparations.

The present invention relates to particles which have been surface-modified by means of colorants and are distinguished by the fact that they are encased with one or more layers of immobilised LCST and/or UCST polymers.

Besides the shape of an article, it is essentially the colouring of an article that influences its appearance. The colouring is therefore also a way of making articles more attractive and thus also increasing their value. Vapour deposition of colorants, as described in DE 10000592 A1, is an expensive and complex method. Simple embedding of colorants in a polymer platelet, as disclosed, for example, in GB 1119748 B1, does not result in particular colour effects (such as, for example, colour flop, metallic lustre).

The object of the present invention is to modify the colour of existing colorants, in particular of pigments, to a great extent in a simple manner. This way of modifying the colour properties is particularly applicable to effect pigments, essentially in interference and metal pigments, since this enables a wide variation of the colour properties, which could originally only be varied in a prespecified range, and thus a considerable broadening of this range. Since these pigments are preferably reflective or interfering pigments in which the absorption of light frequently only plays a minor role, the colour range of these pigments can be significantly widened by immobilisation of absorbent colorants. In the case of interference pigments in which a certain transparency is present, this additionally increases the hiding power.

The invention therefore relates to particles which have been surface-modified by means of colorants and which are encased with one or more layers of immobilised LCST and/or UCST polymers.

By mixing and homogenisation of the colorant with the polymer already present and not formed during the coating process, the colorant is applied more efficiently and homogeneously to the surface of the effect pigment than when the polymer or in general the precipitant is only formed by in-situ polymerisation, the dye is incorporated during the precipitation process, and the dye is thus immobilised on the surface. Processes of this type are disclosed, for example, in U.S. Pat. No. 4,323,554, RU 2133218 C1 and U.S. Pat. No. 5,037,475. The attempt to apply dyes by improved adsorptive (DE 19933138 A1, U.S. Pat. No. 6,113,683, EP 0919598 A2, U.S. Pat. No. 6,022,911) or charge-controlled (U.S. Pat. No. 5,814,686) interaction, as disclosed in DE 19933138 A1, U.S. Pat. No. 6,113,683, EP 0919598 A2, U.S. Pat. No. 6,022,911, U.S. Pat. No. 5,814,686, likewise cannot be assessed as being as efficient as in the present case of the invention, in which the dye is homogenised with the precipitant before the precipitation.

Furthermore, impaired immobilisation, which is often evident from bleeding/blooming of the organic pigment in the coating layer, can be expected on incorporation of an organic colorant into an inorganic matrix owing to the weaker interaction between colorant and matrix, as disclosed, for example, in U.S. Pat. No. 4,323,554 and RU 2133218. Since the present invention uses an organic polymer as colorant immobilisation matrix, bleeding/blooming effects are suppressed to a very great extent and can be excluded by specific adaptation of the polymer to the colorant. The UCST and LCST polymers used in the present invention furthermore exhibit very good interaction with inorganic substances, enabling these likewise to be immobilised on the surface without problems since these substances do not tend towards migration anyway.

Compared with the prior art, the process according to the invention is simpler to carry out (deposition only through a change in the temperature, no charge control, in-situ polymerisation), is more universal (less dependent on surface properties) and is more efficient (since the colorant is homogenised directly in the precipitant and can frequently also be immobilised better).

The invention furthermore relates to the preparation of the surface-modified substrates and to the use thereof, inter alia in surface coatings, water-borne coatings, powder coatings, paints, printing inks, security printing inks, plastics, concrete, as pigment for corrosion protection, as dopant for the laser marking of paper and plastics and laser welding and in cosmetic formulations. The particles according to the invention are furthermore also suitable for the preparation of pigment compositions and for the preparation of dry preparations, such as, for example, granules, pellets, briquettes, etc.

Suitable particles are effect pigments, but also inorganic and organic spherical pigments, such as, for example, titanium dioxide pigments, iron oxide pigments and Cu phthalocyanine pigments.

It is also possible to coat a flake-form substrate, such as, for example, aluminium flakes, Al₂O₃ flakes, SiO₂ flakes, graphite flakes, glass flakes and/or mica directly with organic or inorganic colorants by the process according to the invention in order to produce a novel coloured pigment.

The effect pigments used are preferably commercially available metal-effect pigments, such as, for example, ChromaFlair pigments from Flex, coated or uncoated aluminium flakes, gold-bronze pigments, for example from Eckart, coated iron oxide flakes, such as, for example, Paliochrom® pigments from BASF, Sicopearl pigments from BASF and goniochromatic pigments from BASF, as described, for example, in EP 0 753 545 A2, as well as pearlescent pigments and interference pigments—metal-oxide-coated mica flake pigments—obtainable, for example, from Merck, Darmstadt, under the trade name Iriodin®. The latter are disclosed, for example, in German Patents and Patent Applications 14 67 468, 19 59 998, 20 09 566, 22 14 545, 22 15 191, 22 44 298, 23 13 331, 25 22 572, 31 37 808, 31 37 809, 31 51 343, 31 51 354, 31 51 355, 32 11 602, 32 35 017, DE 38 42 330, DE 41 37 764, EP 0 608 388, DE 196 14 637 and DE 196 18 569. Preference is given to the use of pearlescent pigments based on flake-form substrates. Particularly preferred effect pigments are holographic pigments, conductive and magnetic pigments, metal-effect pigments, for example based on aluminium flakes and/or iron flakes, and effect pigments, such as, for example, pearlescent pigments, interference pigments, goniochromatic pigments and multilayered pigments.

The flake-form substrates are preferably natural or synthetic mica, BiOCl flakes, Al₂O₃ flakes, TiO₂ flakes, SiO₂ flakes, Fe₂O₃ flakes, glass flakes or graphite flakes. Preferred effect pigments are substrates coated with TiO₂ (rutile or anatase), such as, for example, TiO₂-coated natural or synthetic mica, TiO₂-coated SiO₂, Al₂O₃, graphite, glass, Fe₂O₃ or metal flakes, in particular aluminium flakes. In particular, natural or synthetic mica, SiO₂ flakes, Al₂O₃ flakes, glass flakes, ceramic flakes or synthetic support-free flakes are employed as substrate. Preference is furthermore given to multilayered pigments having two, three or more layers comprising one or more TiO₂ layers.

Particularly preferred effect pigments are mentioned below:

substrate+TiO₂

substrate+Fe₂O₃

substrate+Fe₃O₄

substrate+Cr₂O₃

substrate+titanium suboxides

substrate+TiO₂+Fe₂O₃

substrate+TiO₂+SiO₂+TiO₂

substrate+TiO₂/Fe₂O₃+SiO₂+TiO₂

substrate+TiO₂/Fe₂O₃+SiO₂+TiO₂/Fe₂O₃

substrate+TiO₂+SiO₂+TiO₂/Fe₂O₃

substrate+Fe₂O₃+TiO₂+SiO₂+TiO₂

where the substrate preferably comprises mica, Al₂O₃ flakes, SiO₂ flakes, glass flakes or metal flakes or metal-coated inorganic flakes.

It is also possible to stabilise mixtures of different effect pigments by the process according to the invention.

Suitable colorants are all dyes and organic and inorganic coloured pigments known to the person skilled in the art. Particularly suitable organic pigments from the Colour Index list are, for example, monoazo pigments C.I. Pigment Brown 25, C.I. Pigment Orange 5, 13, 36, 67, C.I. Pigment Red 1, 2, 3, 5, 8, 9, 12, 17, 22, 23, 31, 48:1, 48:2, 48:3, 48:4, 49, 49:1, 52:1, 52:2, 53, 53:1, 53:3, 57:1, 251, 112, 146, 170, 184, 210 and 245, C.I. Pigment Yellow 1, 3, 73, 65, 97, 151 and 183; diazo pigments C.I. Pigment Orange 16, 34 and 44, C.I. Pigment Red 144, 166, 214 and 242, C.I. Pigment Yellow 12, 13, 14, 16, 17, 81, 106, 113, 126, 127, 155, 174, 176 and 188; anthanthrone pigments C.I. Pigment Red 168, anthraquinone pigments C.I. Pigment Yellow 147 and 177, C.I. Pigment Violet 31; anthrapyrimidine pigments C.I. Pigment Red 122, 202 and 206, C.I. Pigment Violet 19; quinophthalone pigments C.I. Pigment Yellow 138; dioxazine pigments C.I. Pigment Yellow 138; dioxazine pigments C.I. Pigment Violet 23 and 37; flavanthrone pigments C.I. Pigment Blue 60 and 64; isoindoline pigments C.I. Pigment Orange 69, C.I. Pigment Red 260, C.I. Pigment Yellow 139 and 185; isoindolinone pigments C.I. Pigment Orange 61, C.I. Pigment Red 257 and 260, C.I. Pigment Yellow 109, 110, 173 and 185; isoviolanthrone pigments C.I. Pigment Violet 31, metal-complex pigments C.I. Pigment Yellow 117 and 153, C.I. Pigment Green 8; perinone pigments C.I. Pigment Orange 43, C.I. Pigment Red 194; perylene pigments C.I. Pigment Black 31 and 32, C.I. Pigment Red 123, 149, 178, 179, 190 and 224, C.I. Pigment Violet 29; phthalocyanine pigments C.I. Pigment Blue 15, 15:1, 15:2, 15:3, 15:4, 15:6 and 16, C.I. Pigment Green 7 and 36; pyranthrone pigments C.I. Pigment Orange 51, C.I. Pigment Red 216; thioindigo pigments C.I. Pigment Red 88 and 181, C.I. Pigment Violet 38; triarylcarbonium pigments C.I. Pigment Blue 1, 61 and 62, C.I. Pigment Green 1, C.I. Pigment Red 81, 81:1 and 169, C.I. Pigment Violet 1, 2, 3 and 27; Aniline Black (C.I. Pigment Black 1); Aldazine Yellow (C.I. Pigment Yellow 101) and C.I. Pigment Brown 22 and liquid crystal polymers (LCP pigments).

Particularly preferred organic pigments are Cu Phthalocyanine Blue, Heliogen Blue, Carmine Red, Berlin Blue, azo pigments, azo dyes, perylene pigments, liquid crystal polymers and fluorescent pigments or mixtures thereof.

The colorants are employed in amounts of 0.001-150%, particularly preferably 5-50%, in particular 10-30% % by weight, based on the polymer.

It is also possible to employ mixtures of different colorants, where the total amount should not, however, exceed 150%.

The incorporation of additional scattering particles may also be of interest if an effect is to be muted. In order to achieve this effect, it is advantageous to precipitate a dispersion of the scattering pigment, for example a titanium dioxide pigment, in the LCST or UCST polymer together with a colorant onto an effect pigment.

The proportion of scattering particles is 0-150%, particularly preferably 5-50%, in particular 10-30% % by weight, based on the polymer.

The present invention can also serve significantly to modify the physical properties, in particular with respect to the refractive index, of the surface through the inclusion of transparent substances, in particular of nano-particles. Furthermore, the precipitation of luminescent dyes, fluorescent dyes or phosphorescent dyes using LCST/UCST polymers makes a process accessible which enables often relatively expensive dyes to be applied efficiently to the surface as the uppermost layer. These dyes are frequently used as pure substances, in which case only the surface is effective, or precipitation processes are used in which considerable co-precipitation of the dye occurs. This effect of co-precipitation can be achieved in the present process by slow, controlled precipitation, by optimisation of the LCST or UCST polymer: colorant ratio, by pre-mixing and homogenisation of the polymer with the colorant and through the choice of an LCST/UCST polymer which has a good stabilising action on the colorant below the critical temperature of the polymer.

The deposition of the colorant and any further additives can be carried out by mixing the colorant with the corresponding LCST/UCST polymer (lower critical solution temperature polymers, become insoluble in the medium when the temperature is increased) or UCST polymers (upper critical solution temperature polymers, become insoluble in the medium on cooling). This can occur in dyes by simple admixing of the dye with the polymer with gentle stirring, where, in the case of coloured pigments, dispersal of the coloured pigment in the polymer or in a corresponding polymer solution using a bead mill or shaking machine becomes necessary. The colorant/LCST or UCST polymer mixture is then added to the liquid medium comprising the effect pigments to be coated. It must be ensured here that this takes place at a temperature below the LCST or above the UCST temperature, so that the colorant is stabilised by the polymer. If a temperature change in the direction of the precipitation temperature of the polymer then occurs, the stabilisation of the colorant by the polymer decreases and a polymer/colorant layer precipitates on the surface of the effect pigment, which is then only immobilised by an additionally carried out reaction.

LCST polymers and UCST polymers are polymers which are soluble in a solvent at low and elevated temperatures respectively and are deposited from the solution as a separate phase on increasing and reducing the temperature respectively and reaching the so-called LCST and UCST (lower and upper critical solution temperature) respectively. Polymers of this type are described, for example, in the literature in “Polymere” [Polymers], H.-G. Elias, Hüithig und Wepf-Verlag, Zug, 1996, on pages 183 ff.

Suitable LCST polymers and UCST polymers for the present invention are, for example, those as described in WO 01/60926 A1 and WO 03/014229 A1.

Particularly suitable LCST polymers are polyalkylene oxide derivatives, preferably polyethylene oxide (PEO) derivatives, polypropylene oxide (PPO) derivatives, olefinically modified PPO-PEO block copolymers, acrylate-modified PEO-PPO-PEO three-block copolymers, polymethyl vinyl ether, poly-N-vinylcaprolactam, ethyl(hydroxyethyl)cellulose, poly(N-isopropylacrylamide) and polysiloxanes. Particularly preferred LCST polymers are olefinic-group-modified siloxane polymers or polyethers.

Suitable UCST polymers are, in particular, polystyrene, polystyrene copolymers and polyethylene oxide copolymers.

Preference is given to the use of LCST or UCST polymers containing functional groups which undergo strong interactions and/or form chemical bonds with the effect pigment and the application medium, such as, for example, the coating matrix. All functional groups known to the person skilled in the art are suitable, in particular silanol, amino, hydroxyl, epoxide, acid anhydride and acid groups.

The LCST and UCST polymers preferably have molecular weights in the range from 300 to 500 000 g/mol, in particular from 500 to 20 000 g/mol.

The polymer proportion, based on the end product, is generally 0.1-80% by weight, preferably 1-30% by weight, in particular 1-20% by weight.

The effect pigment is preferably mixed with an immobilisable LCST and/or UCST polymer or polymer mixture comprising one or more colorants in the presence of a solvent. The LCST polymer is dissolved at a temperature below the LCST, while the UCST polymer is dissolved above the UCST. In general, the LCST temperature is 0.5-90° C., preferably 35-80° C., while the UCST temperature is 5-90° C., in particular 35-60° C. If desired, additives are then added. The temperature is subsequently generally increased by about 5° C. above the LCST or lowered by about 5° C. below the UCST, whereupon the polymer precipitates and deposits on the particle surface. Finally, the immobilisation is carried out in the form of crosslinking of the polymer on the particle surface, with the polymer being irreversibly immobilised on the particle surface. The immobilisation can be carried out, for example, by means of free radicals, cationically, anionically or by a condensation reaction. The LCST or UCST polymers are preferably crosslinked by means of free radicals or by a condensation reaction.

For free-radical crosslinking (immobilisation) of the deposited layer in water, use is preferably made of potassium peroxodisulfate or ammonium peroxodisulfate in concentration ranges of 1-100% by weight, based on the olefinic LCST or UCST polymer used for the coating. The crosslinking is carried out, depending on the LCST or UCST temperature of the polymer, at 0-35° C. using a catalyst, such as, for example, an Fe(II) salt, or at 40-100° C. by direct thermal decomposition of the free-radical initiator.

If an organic solvent is required in the process according to the invention, the choice of solvent depends on the solubility of the polymer used. The solvent is preferably water or a water-miscible organic solvent. Water-miscible solvents also include solvents which have miscibility gaps with water. In these cases, the mixing ratios are selected in such a way that miscibility occurs. Examples of suitable solvents are mono- and poly-alcohols, such as, for example, methanol, ethanol, n-propanol, iso-propanol, cyclohexanol, glycol, glycerol, propylene glycol, polyethylene glycol, polybutylene glycol and the mono- and diethers of polyalkylene glycols with methanol, ethanol, propanol and butanol; ethers, such as, for example, tetrahydrofuran, dioxane, 1,2-propanediol propyl ether, 1,2-butane 1-methyl ether, ethylene glycol monomethyl ether, diethylene glycol monomethyl ether; esters, such as, for example, methyl acetate, mono-esters of ethylene glycol or propylene glycols with acetic acid, butyro-lactone; ketones, such as acetone or methyl ethyl ketone; amides, such as formamide, dimethylformamide, dimethylacetamide, N-methylpyrrolidone and hexamethylphosphoric triamide; sulfoxides and sulfones, such as dimethyl sulfoxide and sulfolane; alkanecarboxylic acid, such as formic acid or acetic acid.

The LCST and/or UCST polymer coatings are preferably carried out as complete encasing of the particles. Particular preference is given to effect pigments which have an LCST polymer encasing, in particular of poly-siloxanes, or an alternating LCST and UCST polymer encasing. The effect pigments can also be encased with two or more successive, in each case identical or different LCST or UCST polymers. The effect pigments preferably contain not more than five polymer encasings.

The polymer layer thickness determines, inter alia, the deposition behaviour, the so-called seeding, of the effect pigments. The seeding can be suppressed by selecting the polymer encasing to be correspondingly thick, so that the density of the pigments is influenced. The particles are deposited more slowly and usually are not compacted to the same extent as untreated effect pigments, so that they can easily be stirred up again. The polymer encasing likewise substantially suppresses bleeding of the pigments in the application medium.

Polymer layers of 2-500 nm, preferably 10-200 nm and in particular 20-80 nm, have proven particularly preferred.

Besides the colorant, the individual LCST and/or UCST polymer layers may also comprise additives which additionally increase or reduce the chemical and/or mechanical stability of the particles.

Suitable additives are, for example, nanoparticles, such as, for example, barium sulfate, polymerisable monomers, plasticisers, antioxidants, carbon black particles, microtitanium or mixtures thereof.

The proportion of additives is preferably from 0.001 to 150% by weight, in particular from 0.05 to 100% by weight, based on the polymer employed.

The additives are preferably admixed with the solution of the LCST or UCST polymer in the form of a dispersion, preferably using the same solvent as that of the polymer solution, and the temperature of the dispersion is reduced or increased below the LCST or above the UCST. However, direct dispersal of the additives in the LCST or UCST polymers is also possible if the latter are in liquid form.

The surface modification of the particles with an LCST and/or UCST polymer comprising a colorant modifies the physical parameters of the pigments, such as, for example, the refractive index. Furthermore, the hydrophilicity or hydrophobicity and thus also the surface tension and the interfacial tension of the effect pigments in various application media can also be set in a targeted manner by means of a suitable polymer coating. This results in improved and faster wetting and improved compatibility of the effect pigments with the respective systems. Since the LCST and/or UCST polymer layer is furthermore also able to absorb mechanical stresses, the after-treated effect pigments are also more stable to shear stresses. This is advantageous in particular in corresponding applications of shear-sensitive effect pigments, such as, for example, aluminium pigments and mica-based effect pigments. In the case of metal pigments, the surface modification simultaneously serves as corrosion protection.

In highly crosslinked LCST and UCST polymer coatings, bleeding and blooming of the effect pigments in the application system are furthermore greatly suppressed.

The inclusion of foreign substances, such as, for example, nanoparticles, plasticisers and polymerisable monomers, enables the properties of the polymer layer, such as hardness and degree of crosslinking (reversibility) of the layer, additionally to be influenced. Thus, it is possible, for example, to deposit titanium dioxide nanoparticles with crosslinkable LCST polymer and further monomers as a mixture by precipitation, it being possible to vary the hardness, crosslinking density and hydrophilicity/hydrophobicity depending on the polymer mixture. This mixture is then crosslinked on the surface, it being possible additionally to influence the properties of the deposited polymer layer depending on the crosslinking reaction and amount of crosslinking agent.

If LCST polymers modified with acrylate groups are crosslinked on the surface with, for example, potassium peroxodisulfate, the hydrophilicity of the effect pigment is greatly increased not only by the polymer encasing, but also by the amount of peroxodisulfate employed.

The effect pigments according to the invention preferably have an isoelectric point (pH at which the zeta potential of the pigment becomes zero) in the range from 5 to 10, in particular from 6 to 8, using the ESA (electroacoustic spectral analysis) method.

The surface-modified effect pigments furthermore exhibit very good weathering resistance, very good dispersion behaviour and, owing to their stability, are very highly suitable for a wide variety of application systems, in particular for water-borne and organic surface coatings, particularly preferably for powder coatings.

Effect pigments based on flake-form substrates are generally shear-sensitive. The surface modification of the effect pigments with LCST and/or UCST polymers results in additional-mechanical stabilisation of the pigments at high shear stresses or in abrasive processing methods. The stabilisation can additionally be increased if nanoparticles are additionally admixed with the LCST and/or UCST polymers. Effect pigments stabilised in this way can be subjected to significantly higher shear forces than the untreated effect pigments without a loss of the flake structure.

The effect pigments according to the invention exhibit improved orientation and greatly improved colour values in the surface coating compared with pearlescent pigments which have been treated with a silane in order to improve the leafing behaviour, as described, for example, in EP 0 634 459 A2.

The effect pigments modified in accordance with the invention are compatible with a multiplicity of colour systems, preferably from the area of surface coatings, water-borne coatings, powder coatings, paints, printing inks, security printing inks, plastics and cosmetic formulations. The particles according to the invention, if they have been correspondingly functionalised by the polymer after-treatment, are furthermore suitable as functional pigments, inter alia for the laser marking of papers and plastics, as light protection, as pigment for corrosion protection, for the colouring of concrete and for applications in the agricultural sector, for example for greenhouse sheeting, and also, for example, for the colouring of tarpaulins.

It goes without saying that the particles according to the invention can advantageously also be used for the various applications in the form of a blend with organic dyes, organic pigments or other pigments, such as, for example, transparent and opaque white, coloured and black pigments, and with flake-form iron oxides, organic pigments, holographic pigments, LCPs (liquid crystal polymers), and conventional transparent, coloured and black lustre pigments based on metal-oxide-coated mica, glass, Al₂O₃, graphite and SiO₂ flakes, etc. The particles stabilised in accordance with the invention can be mixed with commercially available pigments and fillers in any ratio.

The surface-modified effect pigments are furthermore suitable for the production of flowable pigment compositions and dry preparations, such as, for example, granules, chips, briquettes, sausages, pellets, etc. The pigment compositions and dry preparations are distinguished by the fact that they comprise at least one or more effect pigments according to the invention, binders and optionally one or more additives. The dry preparations need not be completely dried here, but instead may comprise up to a max. of 8% by weight, preferably 3-6% by weight, of water and/or a solvent or solvent mixture.

The invention thus also relates to formulations which comprise the pigment compositions and dry preparations according to the invention.

The following examples are intended to explain the invention in greater detail, but without limiting it.

### EXAMPLES

### Example 1

### Deposition of a Cu Phthalocyanine Blue Pigment on a Pearlescent Pigment

100 g of Iriodin® 7205 (TiO₂-coated mica pigments having a particle size of 10-60 μm, Merck KGaA) are stirred up with 300 g of water, and 13 g of a Cu Phthalocyanine Blue pigment/LCST polymer composition (1 g of Heliogen Blue pigment, BASF, is dispersed in 10 g of silicone polymer, molecular weight 5000 g/mol, and 10 ml of water for 1 hour using zirconium beads in a bead mill) are added. The mixture is heated with stirring to the LCST temperature of the silicone polymer of 62° C., the temperature is maintained for 45 minutes, and the amino-modified poly-siloxane LCST polymer is immobilised by post-heating at 85° C. with addition of 1 g of an aminoalkyltriethoxysilane and 1 g of an epoxyalkyl-trimethylsilane, where the included dye is also immobilised in the deposited pigment layer. The pigment is filtered off and freed from non-immobilised dye by washing with water and dried.

For characterisation, 0.9 g of pigment is stirred into a nitrocellulose lacquer (solids content about 50%), the resultant lacquer is applied to black/white contrast cards and, after drying at room temperature, analysed colouristically using an X-Rite colorimeter. A comparison is made with the original Iriodin® 7205 pigment which is characterised colouristically in an analogous manner. The following table shows the change in the L, a and b values at angle differences of 15° and 45° from the specular angle (measurement geometries 45/75 and 45/0) relative to the original pigment. The lacquer layer applied over the white area of the contrast card is measured. The results are shown in Table 1.

TABLE 1
Change in colour value on immobilisation of Heliogen
Blue on Iriodin ® 7205 in accordance with Example 1

| | Colour value | | | |
|---|---|---|---|---|
| | a | | b | |
| Angle difference from specular | 15 | 45 | 15 | 45 |
| angle/° | | | | |
| Original sample | −0.57 | −1.40 | 29.03 | −10.49 |
| Modified sample | −2.25 | −3.65 | 29.12 | −13.18 |
| Difference in % | −294.7 | −160.7 | 0.3 | −25.6 |

The results show that the colour of the pigment in the vicinity of the specular angle clearly changes in a greenish direction on coating with the blue absorption pigment, while the blue mass tone of the pigment when viewed perpendicularly to the lacquer sample and its green content is significantly increased.

### Example 2

### Deposition of a Cu Phthalocyanine Blue Pigment on a Pearlescent Pigment

The deposition of the Cu Phthalocyanine Blue pigment is carried out analogously to Example 1, but with 50 g of Iriodin® 504 (Fe₂O₃-coated mica pigments having a particle size of 10-60 μm, Merck KGaA) being stirred up in 300 ml of water, and 16 g of the Cu Phthalocyanine Blue pigment/LCST polymer composition being used. The colour cards for determination of the colouristic properties are also produced analogously. Here too, a clear colour shift takes place in the bluish direction, as shown in Table 2 below.

TABLE 2
Change in colour value on immobilisation of Heliogen
Blue on Iriodin ® 504 in accordance with Example 2

| | Colour value | | | |
|---|---|---|---|---|
| | a | | b | |
| Angle difference from specular angle/° | 15 | 45 | 15 | 45 |
| Original sample | 57.43 | 34.60 | 28.74 | 33.09 |
| Modified sample | 56.48 | 31.34 | 25.68 | 27.82 |
| Difference in % | −1.7 | −9.4 | −10.6 | −15.9 |

The results in Table 2 show that the mass tone of red Iriodin® 504 has shifted in the direction of blue/green, and the interference colour in the vicinity of the specular angle has shifted in the direction of blue.

### Example 3

### Deposition of a Cu Phthalocyanine Blue Pigment on a Pearlescent Pigment

The deposition of the Cu Phthalocyanine Blue pigment is carried out analogously to Examples 1 and 2, again, analogously to Example 2, with 50 g of Iriodin® 307 (Fe₂O₃- and TiO₂-coated mica pigments having a particle size of 10-60 μm, Merck KGaA) being stirred up in 300 ml of water, but only 7 g of a Cu Phthalocyanine Blue pigment/LCST polymer composition, which comprises twice the amount of Heliogen Blue, being used here. The colour cards for determination of the colouristic properties are also produced analogously. Here too, a clear colour shift takes place in the bluish/greenish direction, as shown in Table 3 below.

TABLE 3
Change in colour value on immobilisation of Heliogen
Blue on Iriodin ® 307 Stargold in accordance with
Example 3

| | Colour value | | | |
|---|---|---|---|---|
| | a | | b | |
| Angle difference from specular angle/° | 15 | 45 | 15 | 45 |
| Original sample | 2.23 | 2.32 | 69.85 | 69.85 |
| Modified sample | 0.91 | 4.45 | 61.17 | 20.81 |
| Difference in % | −59.19282 | 99.6 | −12.4 | −70.2 |

The results in Table 3 for modification of Stargold Iriodin® 307 with the blue absorption dye Heliogen Blue show that the interference colour clearly shifts in the direction of green close to the specular angle. The mass tone when the pigmented lacquer surface is viewed perpendicularly is shifted in the reddish/blue direction.

1. Substrates which have been surface-modified by means of colorants, characterised in that they are encased with one or more layers of immobilised LCST and/or UCST polymers.

2. Substrates which have been surface-modified by means of colorants according to claim 1, characterised in that the polymer encasing has layer thicknesses of 2-500 nm.

3. Substrates which have been surface-modified by means of colorants according to claim 1, characterised in that the LCST polymers are selected from the group consisting of polyalkylene oxide derivatives, olefinically modified PEO-PPO copolymers, polymethyl vinyl ether, poly-N-vinylcaprolactam, ethyl(hydroxyethyl)celluloses, poly(N-isopropylacrylamides) and polysiloxanes, and mixtures thereof.

4. Substrates which have been surface-modified by means of colorants according to claim 1, characterised in that the UCST polymers are selected from the group consisting of polystyrenes, polystyrene copolymers and polyethylene oxide copolymers, or mixtures thereof.

5. Substrates which ha ve been surface-modified by means of colorants according to claim 1, characterised in that the LCST polymer is a polysiloxane which has been modified by means of olefinic groups or is a polyether.

6. Substrates which have been surface-modified by means of colorants according to claim 1, characterised in that the polymer encasing additionally comprises nanoparticles, polymerisable monomers, plasticisers, antioxidants, carbon black particles, microtitanium or mixtures thereof.

7. Substrates which have been surface-modified by means of colorants according to claim 6, characterised in that the polymer encasing comprises from 0.001 to 150% by weight of additives, based on the polymer employed.

8. Substrates which have been surface-modified by means of colorants according to claim 1, characterised in that the substrates are holographic pigments, pearlescent pigments, interference pigments, multilayered pigments, metal-effect pigments, goniochromatic pigments, BiOCl pigments, mica, Al₂O₃ flakes, glass flakes and/or SiO₂ flakes.

9. Substrates which have been surface-modified by means of colorants according to claim 8, characterised in that the effect pigments are based on natural or synthetic mica, Al₂O₃ flakes, TiO₂ flakes, SiO₂ flakes, Fe₂O₃ flakes, glass flakes, ceramic flakes or graphite flakes.

10. Substrates which have been surface-modified by means of colorants according to claim 1, characterised in that the colorants are Cu Phthalocyanine Blue, Heliogen Blue, Carmine Red, Berlin Blue, azo pigments, azo dyes, perylene pigments, liquid crystal polymers, fluorescent pigments or mixtures thereof.

11. Process for the preparation of substrates which have been surface-modified by means of colorants according to claim 1, characterised in that the LCST and/or UCST polymer is applied to the substrate surface and irreversibly immobilised by precipitation in water and/or an organic solvent.

12. Process according to claim 11, characterised in that conventional additives are added to the polymer.

13. Use of the substrates which have been surface-modified by means of colorants according to claim 1 in surface coatings, water-borne coatings, powder coatings, paints, printing inks, security printing inks, plastics, concrete, in cosmetic formulations, in agricultural sheeting and tarpaulins, for the laser marking of papers and plastics, for laser welding, as light protection, as pigment for corrosion protection and for the preparation of pigment compositions and dry preparations.

14. Formulations comprising the surface-modified substrates according to claim 1.
